(19) United States
(12) Patent Application Publication
(10) Pub. No.: US 2026/0120702 A1
(43) Pub. Date: Apr. 30, 2026

(54) Adaptive Quantization for Psychoacoustic Audio Coding Using Discrete Cosine Transform-Based Dilation

(71) Applicant: GOOGLE LLC, Mountain View, CA (US)

(72) Inventors: Jyrki Alakuijala, Wollerau (CH); Zoltan Szabadka, Gyorujbarat (HU); Martin Bruse, Stockholm (SE); Andrey Mikhaylov, Zurich (CH)

(21) Appl. No.: 19/361,481

(22) Filed: Oct. 17, 2025

Related U.S. Application Data
(60) Provisional application No. 63/712,979, filed on Oct. 28, 2024.

(51) Int. Cl. G10L 19/032; G06F 17/14

(52) U.S. Cl. CPC G10L 19/032; G06F 17/147

(57) ABSTRACT

A quantized audio signal is received. A decoder generates, based on the quantized audio signal and using a first dequantization operation, at least one local maximum discrete cosine transform (DCT) coefficient. The decoder determines at least one masking function based on the at least one DCT coefficient and generates a set of modified quantized values based on applying the at least one masking function to a set of quantized values of the quantized audio signal. The decoder generates a dequantized audio signal by dequantizing the set of modified quantized values. The decoder generates and outputs a reconstructed audio signal based on the dequantized audio signal.

### CROSS REFERENCE TO RELATED APPLICATIONS

This application claims the benefit of U.S. Provisional Patent Application Ser. No. 63/712,979, filed Oct. 28, 2024, the entire disclosure of which is hereby incorporated herein by reference.

### BACKGROUND

Digital audio signals may represent audio using a sequence of samples that capture sound at discrete intervals. Digital audio can be employed in various applications, including, for example, music streaming, voice communications, sound effects in multimedia presentations, or audio storage for entertainment systems. A digital audio signal can encompass a substantial amount of data, which can place significant demands on the computing or communication resources of a device for processing, transmission, or storage of the audio data. Various approaches have been developed to reduce the amount of data in audio signals, including both lossy and lossless coding techniques.

### SUMMARY

This application relates to encoding and decoding of audio data for transmission and/or storage. Disclosed herein are aspects of systems, methods, and apparatuses for adaptive quantization for psychoacoustic audio coding using discrete cosine transform (DCT)-based dilation.

One aspect of the disclosed implementations relates to a method for decoding an encoded audio signal, including: receiving a quantized audio signal; generating, based on the quantized audio signal and using a first dequantization operation, at least one local maximum discrete cosine transform (DCT) coefficient; determining at least one masking function based on the at least one DCT coefficient; generating a set of modified quantized values based on applying the at least one masking function to a set of quantized values of the quantized audio signal; generating a dequantized audio signal by dequantizing the set of modified quantized values; generating a reconstructed audio signal based on the dequantized audio signal; and outputting the reconstructed audio signal.

One aspect of the disclosed implementations relates to an apparatus for coding an audio signal, the apparatus including: a memory storing instructions; and a processor coupled to the memory and configured to execute the instructions to cause the apparatus to: receive a quantized audio signal; generate, based on the quantized audio signal and using a first dequantization operation, at least one local maximum discrete cosine transform (DCT) coefficient; determine at least one masking function based on the at least one DCT coefficient; generate a set of modified quantized values based on applying the at least one masking function to a set of quantized values of the quantized audio signal; generate a dequantized audio signal by dequantizing the set of modified quantized values; generate a reconstructed audio signal based on the dequantized audio signal; and output the reconstructed audio signal.

One aspect of the disclosed implementations relates to a non-transitory, computer-readable medium storing instructions that, when executed, cause a processor to perform operations, including: receiving a quantized audio signal; generating, based on the quantized audio signal and using a first dequantization operation, at least one local maximum discrete cosine transform (DCT) coefficient; determining at least one masking function based on the at least one DCT coefficient; generating a set of modified quantized values based on applying the at least one masking function to a set of quantized values of the quantized audio signal; generating a dequantized audio signal by dequantizing the set of modified quantized values; generating a reconstructed audio signal based on the dequantized audio signal; and outputting the reconstructed audio signal.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein refers to the accompanying drawings described below, wherein like reference numerals refer to like parts throughout the several views.

FIG. 1 is a schematic of an audio encoding and decoding system.

FIG. 2 is a block diagram of an example of a computing device that can implement a transmitting station or a receiving station.

FIG. 3 is a diagram of a typical audio signal to be encoded and subsequently decoded.

FIG. 4 is a block diagram of an encoder according to implementations of this disclosure.

FIG. 5 is a block diagram of a decoder according to implementations of this disclosure.

FIG. 6 is a diagram depicting an example of frequency-based masking according to implementations of this disclosure.

FIG. 7 is a diagram depicting an example of time-based masking according to implementations of this disclosure.

FIG. 8 is a flow diagram of a method for decoding an encoded audio signal using discrete cosine transform (DCT)-based dilation according to implementations of this disclosure.

FIG. 9 is a schematic diagram illustrating an example of a decoding flow using DCT-based dilation according to implementations of this disclosure.

FIG. 10 is a diagram showing an example of application of a DCT-based dilation function according to implementations of this disclosure.

### DETAILED DESCRIPTION

Audio compression techniques have been developed to transmit audio signals in constrained bandwidth channels and store such signals on media with limited capacity. In this disclosure, the term “audio” refers to a signal that can be any sound in general, such as music of any type, speech, and a mixture of music and voice.

One useful technique for reducing the amount of data sent from an encoder to a decoder to recreate audio samples is a lossy coding referred to as quantization, which is a process used to map a large set of input values to a smaller set. Scalar quantization, which is one of the most commonly used methods, involves quantizing each individual sample of a signal independently. Vector quantization typically searches a codebook (a collection of vectors) for the closest match to an input vector, yielding an output index. A dequantizer simply performs a table lookup in an identical codebook to reconstruct the original vector. Other approaches that do not involve codebooks are known, such as closed form solutions.

Various approaches have been developed to further reduce the amount of data in audio signals, including both lossy and lossless coding techniques One approach involves the use of discrete cosine transform (DCT)-based audio coding, which transforms time-domain audio signals into frequency-domain representations to achieve efficient compression.

The DCT is a mathematical operation that transforms a signal or data from the time or spatial domain into the frequency domain. It is often used in image and video compression algorithms due to its ability to compactly represent signals with fewer coefficients. In the context of audio, the input to the DCT is typically a sequence of time-domain audio samples, such as a segment of sound captured at discrete intervals. The DCT transforms this time-domain data into a sum of cosine functions oscillating at different frequencies. The goal is to represent the original signal using fewer frequency components. DCT assumes the signal to be periodic and symmetric, which allows it to represent the data using only cosine waves (no sine waves).

One of the key advantages of DCT is its energy compaction property. For typical real-world signals (such as audio), a large portion of the signal's energy is concentrated in the lower frequency components after transformation. This allows for a significant reduction in the number of coefficients that need to be retained to accurately reconstruct the original signal.

The output of the DCT is a series of coefficients that represent the amplitude of the cosine waves at different frequencies. Many of these coefficients, especially the ones corresponding to higher frequencies, may have very small values. In lossy compression schemes, these smaller coefficients can be discarded without significantly affecting the perceptual quality of the signal. To reconstruct the original time-domain signal, the inverse DCT (IDCT) is applied to the frequency-domain coefficients. In lossy compression, where some of the coefficients are discarded, the reconstruction may not perfectly match the original signal but can still be perceptually similar, especially if the discarded components represent high-frequency noise or insignificant data.

The Modified DCT (MDCT) is an extension of the DCT, commonly used in audio compression schemes such as MP3 (MPEG-1 Audio Layer III or MPEG-2 Audio Layer III), Advanced Audio Coding (AAC), and others. It is specifically designed to address some limitations of the standard DCT when applied to audio signals, particularly with respect to overlapping windowing and minimizing artifacts between blocks of transformed data. MDCT typically uses overlapping blocks (e.g., time-domain audio samples) of input data. Typically, 50% of one block overlaps with the adjacent blocks. MDCT also applies overlapping windows (e.g., sine or Kaiser-Bessel windows) to taper the edges of each block, ensuring smoother transitions between consecutive blocks.

In contrast, DCT uses non-overlapping blocks (e.g., time-domain audio samples) of data. Thus, in DCT, each block of input data is transformed independently and the transformed output corresponds directly to the input block. Moreover, DCT does apply an overlapping window function. DCT is computationally simpler than MDCT.

Many audio compression techniques rely upon a “psychoacoustic model” to achieve substantial compression. Psychoacoustics describes the relationship between acoustic events and the resulting perceived sounds. Thus, in a psychoacoustic model, the response of the human auditory system is taken into account in order to remove audio signal components that are imperceptible to human ears. In the context of audio coding, psychoacoustic principles are leveraged to reduce data in a way that minimizes perceptible loss of audio quality.

One frequently-used psychoacoustic phenomenon is “masking,” which occurs when certain sounds render other sounds inaudible. Masking can occur in the frequency domain, where a strong sound at one frequency can mask weaker sounds at nearby frequencies, and in the time domain, where a loud sound can mask softer sounds that occur just before (pre-masking) or after (post-masking) it. By incorporating psychoacoustic models that account for these masking effects, audio coders can selectively discard frequency components that are less likely to be perceived by the human auditory system, thereby achieving efficient compression while maintaining perceptual audio quality.

One well-known technique that utilizes a psychoacoustic model is embodied in the MPEG-Audio standard (usually designated MPEG-1 or MPEG-2 but here, simply “MPEG”). An MPEG coder/decoder (“codec”) is an example of an approach employing time domain scalar quantization. In particular, MPEG employs scalar quantization of the time domain signal in individual subbands (typically 32 subbands) while bit allocation in the scalar quantizer is based on a psychoacoustic model, which is implemented separately in the frequency domain (dual-path approach), using MDCT. The masking function is generally indicated in side information with the compressed audio signal to the decoder, which uses the side information in decoding the compressed audio signal. The use of side information and overlapping time-domain samples may result in complex computation and the transmission of more data than is typically transmitted using DCT-based coding.

Implementations of this disclosure describe techniques for adaptive quantization for psychoacoustic coding using DCT-based dilation. In some implementations, the described techniques involve adaptively quantizing DCT coefficients based on the presence of local maxima in the DCT space. For example, some implementations include calculating a “leaking sum” or short moving average of the DCT coefficients, which serves as a proxy for local frequency activity. A dilation operator, based on a masking model, is used to apply the moving average to identified local maxima. The dilation operator effectively creates an “umbrella” around a local maximum, and values of neighboring coefficients that fall below the umbrella are compressed more than values of neighboring coefficients that fall above the umbrella. This process mimics the masking effect of the human auditory system.

Some implementations also incorporate temporal masking, which accounts for the masking effect of audio events in time. Temporal masking may be achieved by extending the leaking sum and dilation operation across multiple packets of the encoded audio signal. This allows the decoder to account for the masking effect of previous packets, further enhancing compression. Some implementations may also be designed to be robust to packet loss, a common issue in audio transmission over the internet. The use of integer-based operations in the DCT space may ensure that the decoder can quickly converge to the correct audio signal even if packets are lost. This soft robustness minimizes the impact of packet loss on the perceived audio quality.

Various implementations described herein combine a novel DCT-based encoding scheme with psychoacoustic masking principles to achieve high compression ratios while maintaining a high level of audio fidelity. Implementations of the disclosed techniques may be particularly well-suited for internet audio transmission, where bandwidth can be an important constraint. These techniques allow for more efficient audio codecs and/or reduced computational complexity compared to conventional approaches.

Implementations of this disclosure describe adaptive quantization for psychoacoustic audio coding using DCT-based dilation for audio compression. Further details of techniques for audio coding using adaptive quantization for psychoacoustic audio coding using DCT-based dilation are described herein with initial reference to a system in which the disclosure may be implemented.

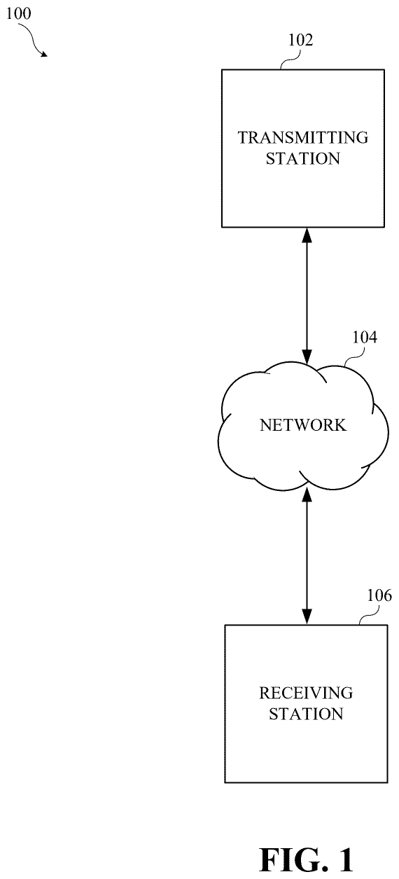

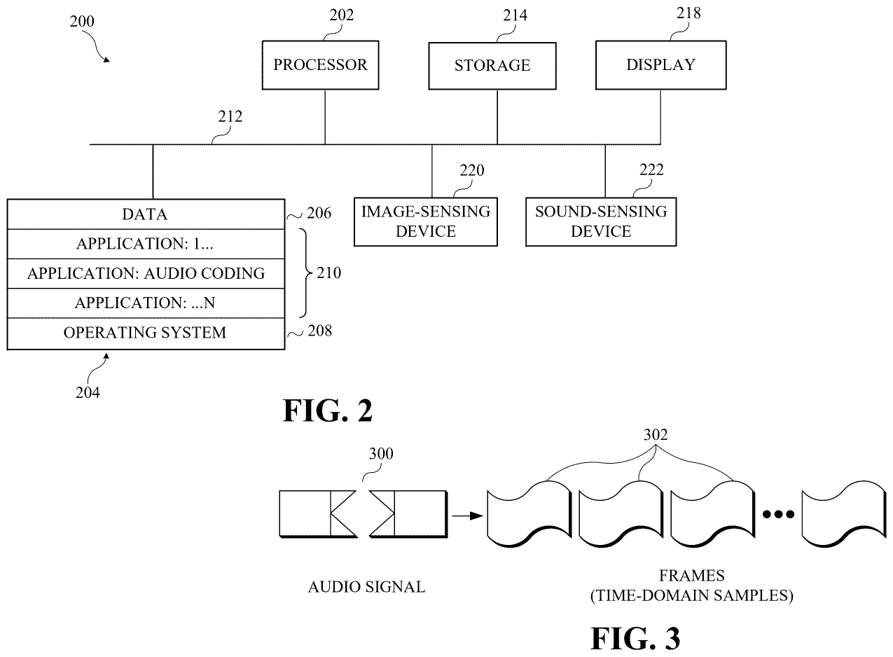

FIG. 1 is a schematic of an audio encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the audio signal. Specifically, the audio signal can be encoded in the transmitting station 102, and the encoded audio signal can be decoded in the receiving station 106. The network 104 can be, for example, the Internet. The network 104 can also be a local area network (LAN), wide area network (WAN), virtual private network (VPN), cellular telephone network, or any other means of transferring the audio signal from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the audio encoding and decoding system 100 are possible. For example, an implementation can omit the network 104. In another implementation, an audio signal can be encoded and then stored for transmission at a later time to the receiving station 106 or any other device having memory. In one implementation, the receiving station 106 receives (e.g., via the network 104, a computer bus, and/or some communication pathway) the encoded audio signal and stores the audio signal for later decoding. In an example implementation, a real-time transport protocol (RTP) is used for transmission of the encoded audio over the network 104. In another implementation, a transport protocol other than RTP may be used, e.g., audio streaming protocol based on the Hypertext Transfer Protocol (HTTP).

When used in an audio and/or video conferencing system, for example, the transmitting station 102 and/or the receiving station 106 may include the ability to both encode and decode an audio signal as described below. For example, the receiving station 106 could be a video conference participant who receives an encoded audio bitstream from a video conference server (e.g., the transmitting station 102) to decode and hear and further encodes and transmits his or her own audio bitstream to the video conference server for decoding and hearing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like. The computing device 200 and/or one or more components thereof may be, be similar to, include, or be included in, an apparatus for performing one or more techniques, processes, and/or methods described herein.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random access memory (RAM) device in an implementation. In some aspects, the memory 204 may include a non-transitory computer-readable medium. Other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include an audio coding application that performs the techniques described herein. The audio coding application may include computer-executable instructions that, when executed by the processor 202, are configured to cause the processor 202 and/or an apparatus (e.g., the computing device 200 and/or one or more components thereof) including the processor 202 to perform one or more aspects of one or more techniques, processes, and/or methods described herein. The computing device 200 can also include a secondary storage 214, which can, for example, be a memory card used with a mobile computing device. Because the audio communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into one unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

FIG. 3 is a diagram of an example of an audio signal 300 to be encoded and subsequently decoded. The audio signal 300 includes a number of frames 302. The audio signal 300 can include any number of frames 302. Each frame 302 may be, be similar to, include, or be included in, a time-domain audio sample, as described herein. In some cases, a frame 302 may be referred to as a “block.”

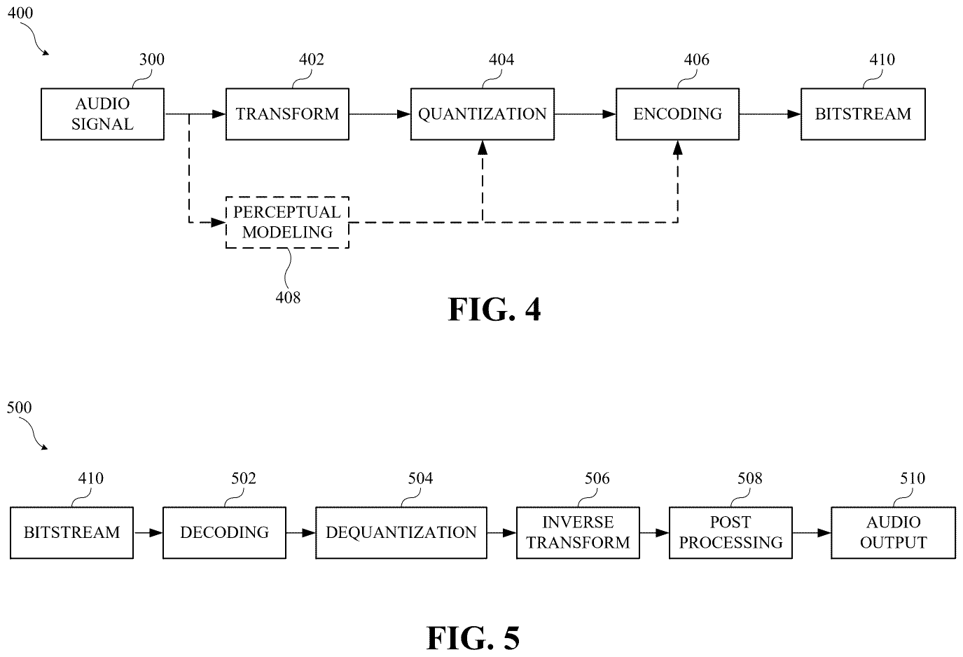

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode audio data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 410 using the audio signal 300 as input: a transform stage 402, a quantization stage 404, and an encoding stage 406. The encoder 400 may also include a perceptual modeling path (shown by the dotted connection lines) to facilitate applying a perceptual model such as a masking model to the quantization stage 404 and/or the encoding stage 406. In FIG. 4, the encoder 400 includes a perceptual modeling stage 408. Other structural variations of the encoder 400 can be used to encode the audio signal 300.

When the audio signal 300 is presented for encoding, respective frames 302 can be processed. The transform stage 402 transforms the frames 302 into transform coefficients in, for example, the frequency domain using a transform. The quantization stage 404 converts the transform coefficients into discrete quantum values, which may be referred to as quantized transform coefficients (or, in the case of DCT, may be referred to as DCT coefficients), using a quantizer value or a quantization level. For example, the transform coefficients may be divided by the quantizer value and truncated.

The quantized transform coefficients are then encoded by the encoding stage 406. In some cases, the encoding stage 406 may include entropy encoding. The encoded coefficients, together with other information used to decode the frame (which may include, for example, syntax elements such as used to indicate a type of prediction used, transform type, motion vectors, a quantizer value, or the like), are then output to the compressed bitstream 410. The compressed bitstream 410 can be formatted using various techniques, such as variable length coding (VLC) or arithmetic coding. The compressed bitstream 410 can also be referred to as an encoded audio signal or encoded audio bitstream, and the terms will be used interchangeably herein.

The parallel perceptual modeling stage 408 may include calculating a “just noticeable” noise level for each band or subband generated in the transform stage 402, in the form of a “signal-to-mask” ratio. This noise level may be used in the quantization stage 404 to determine actual quantizer and quantizer levels. The output of the parallel perceptual modeling stage 408 may be used to adjust bit allocations in the encoding stage 406, in known fashion. Other variations of the encoder 400 can be used to encode the compressed bitstream 410.

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the processor 202, cause the receiving station 106 to decode audio data in the manner described in FIG. 5. The decoder 500 can also be implemented in hardware included in, for example, the transmitting station 102 or the receiving station 106.

The decoder 500 includes, in one example, the following stages to perform various functions to produce an audio output signal 510 from the compressed bitstream 410: a decoding stage 502, a dequantization stage 504, an inverse transform stage 506, and a post processing stage 508. Other structural variations of the decoder 500 can be used to decode the compressed bitstream 410.

When the compressed bitstream 410 is presented for decoding, the data elements within the compressed bitstream 410 can be decoded by the decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a time-domain output signal. The post processing stage 508 can be applied to the time-domain output signal to implement one or more filters, reconstruction operations, and/or the like, and the result is output as the audio output signal 510. The audio output signal 510 can also be referred to as a decoded audio signal, and the terms will be used interchangeably herein. Other variations of the decoder 500 can be used to decode the compressed bitstream 410. In some implementations, the decoder 500 can produce the audio output signal 510 without the post processing stage 508 or otherwise omit the post processing stage 508.

As described above, masking in audio coding may be modeled using psychoacoustic principles that describe how the human auditory system processes and perceives sound. Specifically, masking models account for the fact that certain sounds can obscure or “mask” other sounds, making them imperceptible to listeners. Masking is typically modeled in both the frequency domain and the time domain.

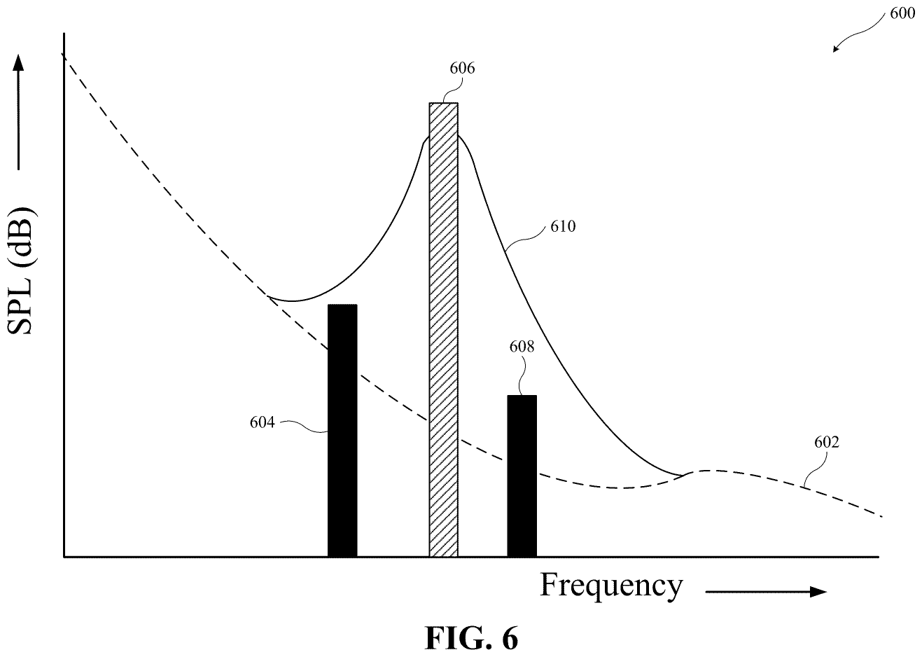

FIG. 6 is a diagram depicting an example 600 of frequency-based masking according to implementations of this disclosure. The example 600 illustrates the concept of frequency-based masking in audio signal processing. The figure depicts a graph with frequency on the x-axis and sound (SPL) in dB on the y-axis.

The graph shows a threshold in quiet 602, represented by a dashed line that curves upward as frequency increases. This threshold represents the minimum sound level that can be perceived by the human ear in the absence of any other sounds. Sounds below this threshold are typically inaudible. A masker 606 is shown as a hatched rectangular region in the middle of the frequency range. This masker represents a strong sound at a specific frequency or range of frequencies. The presence of this masker affects the perception of other sounds in its vicinity.

Two inaudible signals 604 and 608 are depicted as solid black rectangles below and above the masker 606, respectively. These signals, despite being above the threshold in quiet 602, become imperceptible due to the presence of the masker 606. A masking threshold 610 is represented by a solid curved line that extends outward from the masker 606. This threshold illustrates how the presence of the masker 606 affects the perception of nearby frequencies. Sounds that fall below this masking threshold become inaudible, even if they are above the threshold in quiet 602. The masking threshold 610 intersects with the threshold in quiet 602 at higher frequencies, demonstrating the combined effect of both thresholds on auditory perception. This intersection point indicates where the masking effect of the masker 606 diminishes and the threshold in quiet 602 becomes the dominant factor in determining audibility.

As described above, this psychoacoustic phenomenon of frequency-based masking is fundamental to many audio compression techniques. By identifying sounds that are likely to be masked and therefore imperceptible, audio codecs may allocate fewer bits to represent these masked sounds, achieving higher compression ratios without significantly impacting the perceived audio quality. This principle may be applied in various stages of audio coding, including in the quantization and encoding stages, to optimize the use of available bits and improve overall coding efficiency.

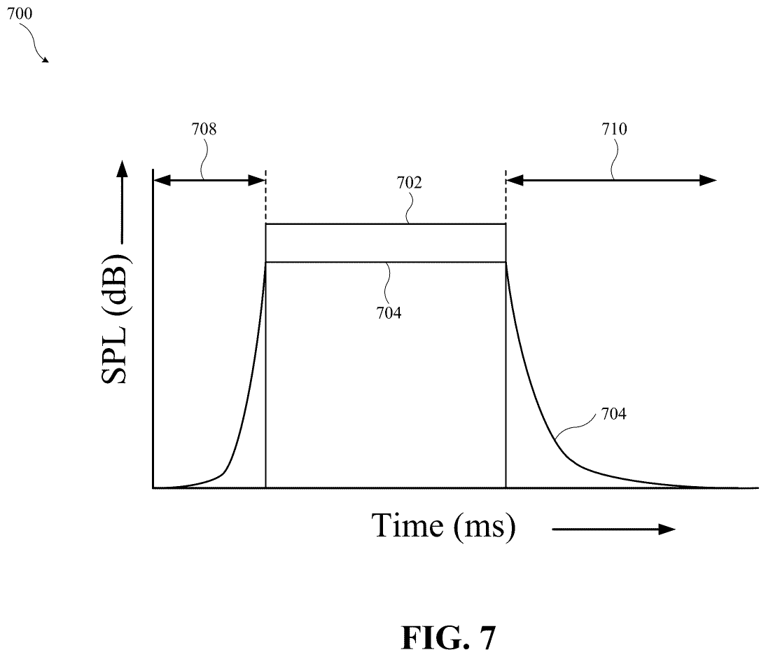

FIG. 7 is a diagram depicting an example 700 of time-based masking according to implementations of this disclosure. The example 700 illustrates the concept of temporal masking in audio signal processing, which is another important psychoacoustic phenomenon utilized in audio compression techniques. The graph shows sound SPL in dB on the y-axis and time in milliseconds (ms) on the x-axis.

In the center of the graph, a masker 702 is represented as a vertical bar. This masker 702 represents a loud sound or signal that occurs at a specific point in time. The presence of this masker 702 affects the perception of other sounds that occur both before and after it in time. A masking threshold 704 is depicted as a curved line extending both before and after the masker 702. This threshold illustrates how the presence of the masker 702 influences the perception of sounds in its temporal vicinity. Sounds that fall below this masking threshold may become inaudible, even if they would be audible in the absence of the masker 702.

The area below the masking threshold 704 and to the left of the masker 702 is referred to as pre-masking 708. Pre-masking occurs when a strong sound masks quieter sounds that precede it in time. This effect is typically short-lived, lasting only a few milliseconds before the onset of the masker 702. Although the masking of a subsequent sound by a preceding sound seems unintuitive, the phenomenon is believed to be a result of the fact that softer sounds have a longer build-up time for cognitive processing in the brain than louder sounds. The area below the masking threshold 704 and to the right of the masker 702 is referred to as post-masking 710. Post-masking occurs when a strong sound masks quieter sounds that follow it in time. This effect may last significantly longer than pre-masking, potentially extending for tens or hundreds of milliseconds after the masker 702 has ended. Post-masking is due to the reduced sensitivity of the ear after a louder sound. The area corresponding to the masker 702 is often referred to as simultaneous masking.

Understanding and modeling temporal masking may allow audio compression algorithms to more efficiently allocate bits in the time domain. By identifying time periods where sounds may be masked and therefore imperceptible, these algorithms may reduce the bit allocation for these periods, potentially achieving higher compression ratios without significantly impacting the perceived audio quality. This temporal masking effect may be particularly useful in handling transient sounds or in smoothing the transition between audio frames in compressed audio signals.

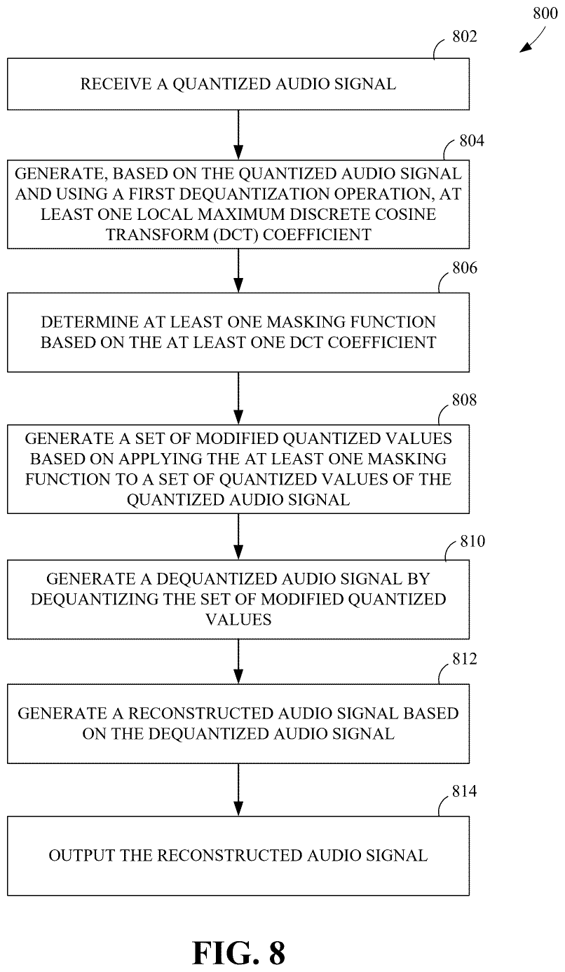

FIG. 8 is a flow diagram of a technique 800 for decoding an encoded audio signal using DCT-based dilation according to implementations of this disclosure. The technique 800 may be performed by a decoder (such as the decoder 500 shown in FIG. 5) and/or one or more components of the computing device 200 depicted in FIG. 2. A decoder (such as the decoder 500 shown in FIG. 5) may receive a current bitstream.

At 802, the decoder receives a quantized audio signal. This step may involve receiving a compressed bitstream 410, as shown in FIG. 5, which contains encoded audio data. In some implementations, the quantized audio signal may be extracted from the compressed bitstream 410 by the decoding stage 502 of the decoder 500. Alternatively, the quantized audio signal may be received directly from a transmission channel or retrieved from a storage medium.

At 804, at least one local maximum DCT coefficient is generated based on the quantized audio signal using a first dequantization operation. This step may be performed by the dequantization stage 504 of the decoder 500 shown in FIG. 5. The first dequantization operation may involve multiplying the quantized transform coefficients by a quantizer value to obtain the DCT coefficients. In some implementations, the local maximum DCT coefficients may be identified by comparing the magnitude of each DCT coefficient with its neighboring coefficients. Alternatively, a threshold value may be used to determine which DCT coefficients are considered local maxima.

In some implementations, the decoding process may initially dequantize a small number of coefficient values, such as the 8 highest values or their indices. These initially dequantized values may be used to determine subsequent quantization for neighboring values. By utilizing this approach, the decoder may adaptively adjust the quantization process based on the characteristics of the most significant coefficients. This method may allow for more efficient bit allocation and potentially improve the overall quality of the reconstructed audio signal. The information derived from these initial coefficients may be used to fine-tune the dequantization of the remaining coefficients, potentially leading to better preservation of perceptually important audio features.

At 806, at least one masking function is determined based on the at least one DCT coefficient. This step incorporates psychoacoustic principles into the decoding process by modeling the masking effects observed in human auditory perception, as illustrated in FIG. 6 and FIG. 7. The masking function may correspond to a human auditory system masking function in the frequency domain, similar to the masking threshold 610 shown in FIG. 6. In some implementations, the masking function may also incorporate temporal masking effects, as depicted in FIG. 7, to account for pre-masking 708 and post-masking 710 phenomena.

In some aspects, the at least one masking function may comprise a moving average function. This moving average function may serve as a proxy for local frequency activity and may be calculated based on a short-term average of the DCT coefficients. Alternatively, the masking function may be determined using more complex psychoacoustic models that take into account factors such as critical bands, simultaneous masking, and temporal masking.

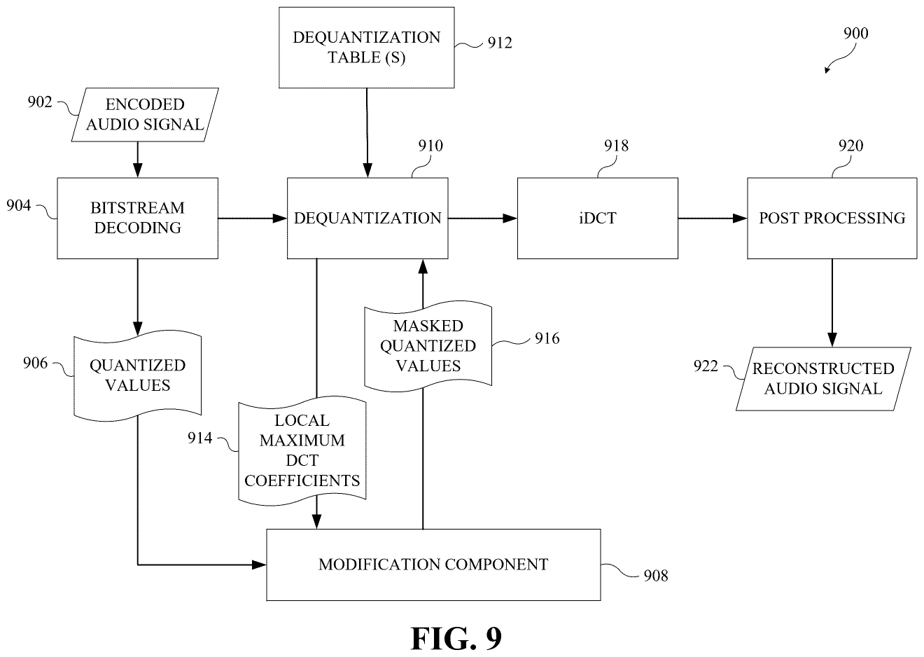

At 808, the decoder generates a set of modified quantized values by applying the at least one masking function to a set of quantized values of the quantized audio signal. This step may be performed by a modification component, such as the modification component 908 shown in FIG. 9. The application of the masking function to the quantized values may involve a dilation operation, where the masking function creates an “umbrella” around local maximum DCT coefficients. In some implementations, quantized values that fall below this umbrella may be compressed more than values that fall above the umbrella, mimicking the masking effect of the human auditory system.

In some aspects, generating the set of modified quantized values includes modifying a first quantized value of the set of quantized values based on the at least one masking function; and modifying a second quantized value of the set of quantized values based on the at least one masking function, wherein the second quantized value is adjacent to the first quantized value. In some aspects, generating the set of modified quantized values includes determining a first masking function, of the at least one masking function, based on a first local maximum DCT coefficient of the at least one local maximum DCT coefficient; modifying a first quantized value of the set of quantized values based on the first masking function; determining a second masking function based on the first local maximum DCT coefficient and a second local maximum DCT coefficient of the at least one local maximum DCT coefficient; and modifying a second quantized value of the set of quantized values based on the second masking function.

In some aspects, generating the set of modified quantized values includes modifying a first quantization value of the set of quantized values based on the at least one masking function; dequantizing a first quantized value of the set of quantized values using the first quantization value based on the at least one masking function; and dequantizing a second quantized value of the set of quantized values using a second quantization value based on the at least one masking function, wherein the first quantized value is greater than a value of the at least one masking function and the second quantized value is less than the value of the at least one masking function.

In some aspects, the at least one masking function includes a set of three or more masking functions, and wherein the set of modified quantized values includes generating a first proper subset of the set of modified quantized values based on a first proper subset of the set of three or more masking functions; and generating a second proper subset of the set of modified quantized values based on a second proper subset of the set of three or more masking functions, wherein a masking function of the second proper subset is based on the first proper subset of the set of modified quantized values. In some aspects, the first proper subset of the set of modified quantized values may correspond to a first packet and the second proper subset of the set of modified quantized values may correspond to a second packet adjacent the first packet. In some aspects, the first proper subset of the set of modified quantized values may correspond to a first time interval and the second proper subset of the set of modified quantized values may correspond to a second time interval adjacent the first time interval.

In some aspects, the at least one masking function may include a plurality of masking functions, each corresponding to a respective local maximum DCT coefficient or to a respective quantized value of the set of quantized values. This allows for a more granular application of masking effects across the frequency spectrum. Additionally, the masking functions may be interdependent, with the second masking function being based on the first local maximum DCT coefficient or on an average of multiple local maximum DCT coefficients.

In some implementations, the decoder may employ a leaking sum or short moving average of the quantized DCT coefficients. This leaking sum may act as an exponential decay function, providing a measure of local frequency activity that adapts to changes in the audio signal over time. The use of a leaking sum may allow the decoder to maintain a memory of recent coefficient values while gradually reducing the influence of older values, potentially improving the accuracy of the masking function in representing the current state of the audio signal.

The masking function may be implemented as a dilation operator that manipulates the quantization table for the coefficients. This dilation operator may take a maximum unquantized value and propagate its effect between neighboring coefficients. By applying the dilation operator in the DCT space, the decoder may be able to model the spreading of masking effects across frequencies more accurately. The dilation process may involve placing an “umbrella” shape at each local maximum, with the envelope of all these umbrellas forming the new dilation of the function.

In some aspects, the decoder may use a function that maps the value after dilation to a quantization value. This function may vary depending on different quality settings and frequencies. For example, higher frequencies may be quantized more aggressively because human hearing thresholds are typically higher in these ranges. This approach may allow the decoder to adapt its quantization strategy based on both the local signal characteristics and known properties of human auditory perception.

The decoding technique may have the advantage of matching both frequency masking and temporal masking experiences without requiring side information about these phenomena in the data stream. As the decoder processes the 64 DCT coefficients in order from 0 to 63, it may adjust its quantization strategy based on the values of previous coefficients. For instance, when a high value is encountered, or when the average of the last four coefficients is high, the decoder may quantize the next coefficient more aggressively than it would if the preceding coefficients were low. This adaptive approach may allow the decoder to respond dynamically to local variations in the audio signal's frequency content. In some implementations, the decoder may estimate the masking-caused quantization and may perform an operation to cause a sum of local DCT coefficients to match pervious blocks' alternating sum of local coefficients (e.g., by causing a Gaussian of an alternating sum of local coefficients to match the Gaussian of the prior values). In this way, the decoder may reduce block-to-block disparity.

At 810, a dequantized audio signal is generated by dequantizing the set of modified quantized values. This step may be performed by the dequantization stage 504 of the decoder 500 shown in FIG. 5, or by a separate dequantization component such as the dequantization component 910 shown in FIG. 9. The dequantization process may involve using a dequantization table, such as the dequantization table 912 in FIG. 9, to convert the modified quantized values back into the frequency domain.

At 812, a reconstructed audio signal is generated based on the dequantized audio signal. This step may involve applying an inverse transform, such as an inverse DCT (iDCT), to convert the dequantized signal from the frequency domain back to the time domain. This operation may be performed by the inverse transform stage 506 of the decoder 500 shown in FIG. 5, or by an inverse DCT component such as the inverse DCT component 918 shown in FIG. 9.

At 814, the reconstructed audio signal is output. This step may involve further processing of the reconstructed audio signal, such as applying filters or other reconstruction operations in the post processing stage 508 of the decoder 500 shown in FIG. 5, or in the post processing component 920 shown in FIG. 9. The resulting audio output signal 510 represents the decoded version of the original encoded audio signal.

In some implementations, the technique 800 may incorporate additional steps or variations to enhance the decoding process. For example, the technique may include steps to handle packet loss in audio transmission over networks. This may involve extending the masking functions across multiple packets of the encoded audio signal, allowing the decoder to account for the masking effect of previous packets and ensuring robustness to packet loss. The specific implementation may be optimized based on the characteristics of the audio content or the requirements of the codec, allowing for flexibility in various audio coding applications.

FIG. 9 is a schematic diagram illustrating an example of a decoding flow 900 using DCT-based dilation according to implementations of this disclosure. The decoding flow 900 may be performed by a decoder (such as the decoder 500 shown in FIG. 5) and/or one or more components of the computing device 200 depicted in FIG. 2.

The decoder receives an encoded audio signal 902 as input, which may be a compressed bitstream containing quantized audio data. The encoded audio signal 902 is first processed by a bitstream decoding component 904. This component may perform the initial decoding of the compressed bitstream, extracting quantized values 906 from the encoded data. The bitstream decoding component 904 may implement various decoding algorithms depending on the specific encoding scheme used, such as Huffman decoding or arithmetic decoding.

The extracted quantized values 906 are then passed to a modification component 908, while some are also provided to the dequantization component 910. For example, quantized values corresponding to local maxima may be provided to the dequantization component 910. The dequantization component 910 dequantizes the quantized values to generate local maximum DCT coefficients 914, which are provided to the modification component 908. The modification component 908 also may receive a dequantization table 912. The local maximum DCT coefficients 914 are derived from the quantized values 906, potentially using the technique described in step 804 of FIG. 8, where at least one local maximum DCT coefficient is generated based on the quantized audio signal using a first dequantization operation. The dequantization table 912 provides information for the inverse quantization process. This table may contain the quantization step sizes or scaling factors used during the encoding process. In some implementations, the dequantization table 912 may be adaptive, changing based on the characteristics of the audio signal or the desired output quality.

The modification component 908 applies one or more masking functions to the quantized values 906, as described in steps 806 and 808 of FIG. 8. These masking functions may be determined based on the local maximum DCT coefficients 914 and may incorporate both frequency and temporal masking effects. A masking function may be based on a corresponding local maximum DCT coefficient, as well as a dilation operator. The dilation operator may function to carry forward a “leaking sum” or a moving average, or any other aggregate value that propagates the effect of a maximum unquantized (or dequantized) value between other coefficients. In some cases, the dilation operator may be determined based on the last local maximum coefficient and half of the history of the last value. In some implementations, the masking function may modify a quantizer, a dequantized value, or a combination of both. In some implementations, the dilation operator behaves like a decaying function. For example, in some implementations, the dilation operator results in quantization in logarithmic space, which enables a maximum value and its impact on subsequent quantization to taper off.

In this manner, for example, if the average of the prior four (or any other quantity) local maximum coefficients was high, the next coefficient may be quantized more (e.g., compressed more) than if the average was lower. In some implementations, by adjusting the maximum as the decoder proceeds along the signal, it is developing a mask that is more particular for each subsequent local maximum. This way, the dilation operator slowly “forgets” high values until the frequency is higher than the decayed masking effect, essentially eliminating the masking effect over time. In some implementations, therefore, the dilation is non-linear.

The modification component 908 generates a set of masked quantized values 916, which represent the modified quantized values after applying the masking functions. In some implementations, the modification component 908 may employ multiple masking functions, each corresponding to different frequency ranges or temporal windows. This approach allows for more fine-grained control over the dequantization process, potentially improving the perceptual quality of the reconstructed audio signal.

The masked quantized values 916 are then processed by the dequantization component 910. This component performs the inverse quantization operation, converting the masked quantized values back into the frequency domain. The dequantization component 910 uses the dequantization table 912 to determine the appropriate scaling factors for each coefficient. In some aspects, the dequantization process may involve multiplying the masked quantized values by the corresponding entries in the dequantization table 912.

The output of the dequantization component 910 is then passed to an inverse DCT (iDCT) component 918. This component transforms the frequency domain signal back into the time domain, effectively reversing the DCT operation performed during encoding. The iDCT component 918 may implement various algorithms for efficient computation of the inverse DCT. The time domain signal may undergo post processing in the post processing component 920. This component may perform various operations to enhance the quality of the reconstructed audio signal. For example, it may apply noise reduction techniques, perform dynamic range compression, or implement other audio enhancement algorithms. The specific post-processing operations may be tailored to the characteristics of the audio content or the requirements of the playback system.

The output of the post processing component 920 is the reconstructed audio signal 922, which represents the decoded version of the original encoded audio signal 902. This reconstructed signal may be further processed for playback or storage, depending on the specific application.

In some implementations, the decoding flow 900 may incorporate additional operations or modify the existing ones to handle specific requirements. For instance, an error concealment component may be added to handle packet loss in network transmission scenarios. Such a component could work in conjunction with the modification component 908 to estimate missing coefficients based on surrounding data and psychoacoustic principles. Moreover, the decoding flow 900 may be optimized for different types of audio content. For example, when dealing with speech signals, the masking functions applied by the modification component 908 may be tailored to the characteristics of human speech, potentially improving the intelligibility of the reconstructed signal.

In summary, the decoding flow 900 illustrated in FIG. 9 provides a comprehensive example of how the invention's adaptive quantization techniques using DCT-based dilation can be implemented in a practical audio decoding system. By incorporating psychoacoustic principles and adaptive processing at various stages, this system may facilitate achieving high-quality audio reconstruction while maintaining computational efficiency.

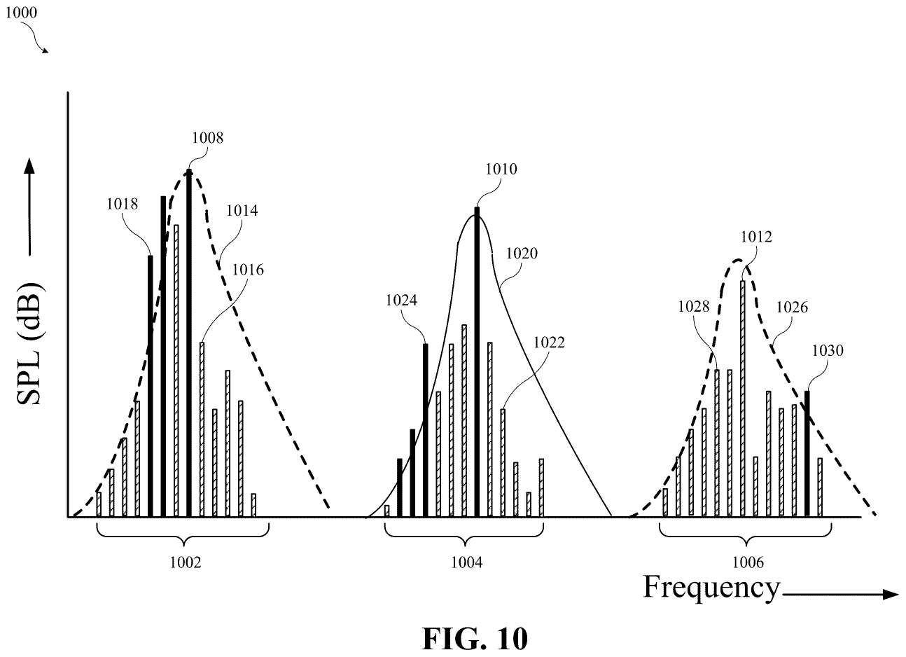

FIG. 10 is a diagram showing an example 1000 of application of a DCT-based dilation function according to implementations of this disclosure. The example 1000 provides a visual representation of how the dilation function may be applied to DCT coefficients, as described above in connection with FIGS. 8 and 9.

The example 1000 depicts three audio samples 1002, 1004, and 1006, each represented as a group of horizontal bars along the frequency axis. These audio samples may correspond to different frames or time intervals of the quantized audio signal received in step 802 of FIG. 8. Each audio sample contains a local maximum coefficient, represented by local maximum coefficient 1008 for audio sample 1002, local maximum coefficient 1010 for audio sample 1004, and local maximum coefficient 1012 for audio sample 1006. These local maximum coefficients may be generated using the first dequantization operation described in step 804 of FIG. 8.

Masking functions 1014 and 1020 are depicted as dashed curves extending from the local maximum coefficients, illustrating the masking effect on nearby frequencies. These masking functions 1014 and 1020 (representative of the “umbrellas” discussed above) may be determined based on the respective local maximum DCT coefficients 1008 and 1010, as described in step 806 of FIG. 8. The shape and extent of these masking functions may be influenced by psychoacoustic models that account for both frequency and temporal masking effects.

Coefficients 1016 that fall below the masking function 1014 may be compressed more than coefficients 1018 that fall above the masking function 1014, as described herein. For example, for coefficients 1018 that fall below the masking function 1014, a quantizer may be modified (and/or a dequantized value may be modified) based on the masking function 1014. Similarly, coefficients 1022 that fall below the masking function 1020 may be compressed more than coefficients 1024 that fall above the masking function 1020.

In some implementations, the masking function 1014 may be determined based on the local maximum coefficient 1008, while the masking function 1020 may be based on the local maximum coefficient 1010. In some implementations, the masking function 1020 may further be based on the local maximum coefficient 1008, which may be carried forward, as part of a “leaking sum” or a moving average via a dilation function, as described herein. Similarly, a masking function 1026 may be based on the local maximum coefficient 1012 as well as the local maximum coefficient 1010 and/or the local maximum coefficient 1008, due to the dilation function. As a result, as shown in FIG. 10, the audio sample 1006 may be compressed more than the audio sample 1002 and 1004, as coefficients 1028 under the masking function 1026 may be compressed more than the very few coefficients 1030 above the masking function. In some implementations, a masking function may extend across multiple audio samples. This approach may help in handling packet loss scenarios and in capturing temporal masking effects.

According to the disclosure herein, improvements to audio coding may be achieved by using one or more aspects of the adaptive quantization techniques for psychoacoustic coding described herein.

The word “example” or the like is used herein to mean serving as an example, instance, or illustration. Any aspect or design described herein as “example” or the like is not necessarily to be construed as being preferred or advantageous over other aspects or designs. Rather, use of the word “example” or the like is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices described herein.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized that can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded audio signal and transmit the encoded audio signal to the communications device. In turn, the communications device can then decode the encoded audio signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described embodiments, implementations, and aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

What is claimed is:

1. A method for decoding an encoded audio signal, comprising:
receiving a quantized audio signal;
generating, based on the quantized audio signal and using a first dequantization operation, at least one local maximum discrete cosine transform (DCT) coefficient;
determining at least one masking function based on the at least one DCT coefficient;
generating a set of modified quantized values based on applying the at least one masking function to a set of quantized values of the quantized audio signal;
generating a dequantized audio signal by dequantizing the set of modified quantized values;
generating a reconstructed audio signal based on the dequantized audio signal; and
outputting the reconstructed audio signal.

2. The method of claim 1, wherein the at least one masking function comprises:
a first masking function corresponding to a first local maximum DCT coefficient of the at least one local maximum DCT coefficient; and
a second masking function corresponding to a second local maximum DCT coefficient of the at least one local maximum DCT coefficient, wherein the second masking function is based on the first local maximum DCT coefficient.

3. The method of claim 1, wherein the at least one masking function comprises:
a first masking function corresponding to a first local maximum DCT coefficient of the at least one local maximum DCT coefficient; and
a second masking function corresponding to a second local maximum DCT coefficient of the at least one local maximum DCT coefficient, wherein the second masking function is based on an average of the first local maximum DCT coefficient and the second local maximum DCT coefficient.

4. The method of claim 1, wherein the at least one masking function comprises:
a first masking function corresponding to a first local maximum DCT coefficient of the at least one local maximum DCT coefficient; and
a second masking function corresponding to a second local maximum DCT coefficient of the at least one local maximum DCT coefficient, wherein the second masking function is based on a moving average of the first local maximum DCT coefficient and at least one other local maximum DCT coefficient of the at least one local maximum DCT coefficient.

5. The method of claim 1, wherein generating the set of modified quantized values comprises:
modifying a first quantized value of the set of quantized values based on the at least one masking function; and
modifying a second quantized value of the set of quantized values based on the at least one masking function, wherein the second quantized value is adjacent to the first quantized value.

6. The method of claim 1, wherein generating the set of modified quantized values comprises:
determining a first masking function, of the at least one masking function, based on a first local maximum DCT coefficient of the at least one local maximum DCT coefficient;
modifying a first quantized value of the set of quantized values based on the first masking function;
determining a second masking function based on the first local maximum DCT coefficient and a second local maximum DCT coefficient of the at least one local maximum DCT coefficient; and
modifying a second quantized value of the set of quantized values based on the second masking function.

7. The method of claim 1, wherein generating the set of modified quantized values comprises:
modifying a first quantization value of the set of quantized values based on the at least one masking function;
dequantizing a first quantized value of the set of quantized values using the first quantization value based on the at least one masking function; and
dequantizing a second quantized value of the set of quantized values using a second quantization value based on the at least one masking function, wherein the first quantized value is greater than a value of the at least one masking function and the second quantized value is less than the value of the at least one masking function.

8. The method of claim 1, wherein the at least one masking function comprises a set of three or more masking functions, and wherein generating the set of modified quantized values comprises:
generating a first proper subset of the set of modified quantized values based on a first proper subset of the set of three or more masking functions; and
generating a second proper subset of the set of modified quantized values based on a second proper subset of the set of three or more masking functions, wherein a masking function of the second proper subset is based on the first proper subset of the set of modified quantized values.

9. The method of claim 8, wherein the first proper subset of the set of modified quantized values corresponds to a first packet and the second proper subset of the set of modified quantized values corresponds to a second packet adjacent the first packet.

10. The method of claim 8, wherein the first proper subset of the set of modified quantized values corresponds to a first time interval and the second proper subset of the set of modified quantized values corresponds to a second time interval adjacent the first time interval.

11. An apparatus for coding an audio signal, the apparatus comprising:
a memory storing instructions; and
a processor coupled to the memory and configured to execute the instructions to cause the apparatus to:
receive a quantized audio signal;
generate, based on the quantized audio signal and using a first dequantization operation, at least one local maximum discrete cosine transform (DCT) coefficient;
determine at least one masking function based on the at least one DCT coefficient;
generate a set of modified quantized values based on applying the at least one masking function to a set of quantized values of the quantized audio signal;
generate a dequantized audio signal by dequantizing the set of modified quantized values;
generate a reconstructed audio signal based on the dequantized audio signal; and
output the reconstructed audio signal.

12. The apparatus of claim 11, wherein the at least one masking function corresponds to a human auditory system masking function in a time domain.

13. The apparatus of claim 11, wherein the at least one masking function corresponds to a human auditory system masking function in a frequency domain.

14. The apparatus of claim 11, wherein the at least one masking function comprises a moving average function.

15. The apparatus of claim 11, wherein the at least one masking function comprises:
a first masking function corresponding to a first local maximum DCT coefficient of the at least one local maximum DCT coefficient; and
a second masking function corresponding to a second local maximum DCT coefficient of the at least one local maximum DCT coefficient, wherein the second masking function is based on the first local maximum DCT coefficient.

16. The apparatus of claim 11, wherein the at least one masking function comprises:
a first masking function corresponding to a first local maximum DCT coefficient of the at least one local maximum DCT coefficient; and
a second masking function corresponding to a second local maximum DCT coefficient of the at least one local maximum DCT coefficient, wherein the second masking function is based on an average of the first local maximum DCT coefficient and the second local maximum DCT coefficient.

17. The apparatus of claim 11, wherein the at least one masking function comprises:
a first masking function corresponding to a first local maximum DCT coefficient of the at least one local maximum DCT coefficient; and
a second masking function corresponding to a second local maximum DCT coefficient of the at least one local maximum DCT coefficient, wherein the second masking function is based on a moving average of the first local maximum DCT coefficient and at least one other local maximum DCT coefficient of the at least one local maximum DCT coefficient.

18. A non-transitory, computer-readable medium storing instructions that, when executed, cause a processor to perform operations, comprising:
receiving a quantized audio signal;
generating, based on the quantized audio signal and using a first dequantization operation, at least one local maximum discrete cosine transform (DCT) coefficient;
determining at least one masking function based on the at least one DCT coefficient;
generating a set of modified quantized values based on applying the at least one masking function to a set of quantized values of the quantized audio signal;
generating a dequantized audio signal by dequantizing the set of modified quantized values;
generating a reconstructed audio signal based on the dequantized audio signal; and
outputting the reconstructed audio signal.

19. The non-transitory, computer-readable medium of claim 18, wherein the at least one masking function comprises a plurality of masking functions, each of the plurality of masking functions corresponding to a respective local maximum DCT coefficient of the at least one local maximum DCT coefficient.

20. The non-transitory, computer-readable medium of claim 18, wherein the at least one masking function comprises a plurality of masking functions, each of the plurality of masking functions corresponding to a respective quantized value of the set of quantized values of the quantized audio signal.
